(19) United States
(12) Patent Application Publication
(10) Pub. No.: US 2020/0040538 A1
(43) Pub. Date: Feb. 6, 2020

(54) SNOW BLOWER

(71) Applicant: Didier NKURUNZIZA, Ottawa (CA)

(72) Inventor: Didier NKURUNZIZA, Ottawa (CA)

(21) Appl. No.: 16/494,983

(22) PCT Filed: Mar. 20, 2018
(86) PCT No.: PCT/CA2018/050335

§ 371 Date: Sep. 17, 2019

Related U.S. Application Data
(60) Provisional application No. 62/601,439, filed on Mar. 22, 2017.
(60) Provisional application No. 62/522,850, filed on Jun. 21, 2017.

(51) Int. Cl. E01H 5/02; B60S 3/04

(52) U.S. Cl. CPC E01H 5/02; E01H 5/098; B60S 3/045

(57) ABSTRACT

A snow blower (10) for blowing snow off a surface. The snow blower (10) comprises a body (50) comprising an intake port (120); a discharge port (318); and a conduit (202) having an interior wall (212). The conduit (202) is fluidly connecting the intake port (120) to the discharge port (318). The snow blower (10) further comprises an electric circuit (114) housed by the body (50) and connected to a power source; an electric blower (104) housed by the body (50) and powered by the electric circuit (114) for drawing air from the intake port (120); and a heating coil (210) electrically connected to the electric circuit (114) and extending along a portion of the interior wall (212). The air is forced through the conduit (202), heated by the heating coil (210) and exhausted at the discharge port (318) to blow snow off the surface.

### CROSS-REFERENCE TO RELATED APPLICATION

This application claims priority from U.S. patent provisional application 62/601,439 filed Mar. 22, 2017 and from U.S. patent provisional application 62/522,850 filed Jun. 21, 2017, the specifications of which are hereby incorporated herein by reference in its entirety.

### BACKGROUND

### (a) Field

The present disclosure relates to the field of vehicle maintenance accessories, but more particularly to vehicle snow blowers.

### (b) Related Prior Art

As is generally well known, snow removal is accomplished either by using a shovel or a power operated ground engaging snow blower. Use of a shovel generates undesired stresses onto a lower back portion of the user and causes fatigue when large amounts of snow must be removed.

Use of a traditional ground engaging powered snow blower equipment alleviates the problem of lower back stresses and user fatigue. However, such equipment is difficult to maneuver and may be cumbersome for users with limited physical strength. Furthermore, traditional snow blowers are disadvantaged in cleaning elevated surfaces such as steps and porches.

Additionally, the use of a shovel or traditional snow blower equipment fails to completely remove snow and ice build-up from the ground surface.

Snow and ice on cars and other delicate surfaces require special devices adapted to prevent deterioration of the delicate surfaces, preventing scratching the car paint for instance. Use of specialized snow brooms, with an ice scraper extremity, are usually used for this application. Powered alternatives also include heat ice scraper featuring an electrically heated element housed in a handheld device that is used to melt the ice off the windshields and other glass areas.

However, none of these solutions is well adapted to a variety of conditions, including de-icing small areas, removing snow and de-ice of a car for instance.

Therefore, there is a need for an improved portable apparatus for removing snow and ice build-up and which significantly removes such snow and ice build-up.

### SUMMARY

According to an embodiment, there is provided a snow blower for removal of at least one of snow and ice from a surface, the snow blower comprising: a body; an intake port; a discharge port; a conduit having an interior wall, the conduit fluidly connecting the intake port to the discharge port; a power source housed within the body; an electric circuit housed within the body and electrically connected to the power source; an electric blower housed within the body and powered by the electric circuit; and a heating coil electrically connected to the electric circuit and extending along at least a portion of the interior wall, wherein air is forced by the electric blower from the intake port through the conduit, heated by the heating coil and exhausted at the discharge port to contribute to remove the at least one of snow and ice from the surface.

According to an aspect, the snow blower further comprises: an extension duct which forms the conduit; and a nozzle, wherein the nozzle is releasably attached and fluidly connected to the extension duct, and wherein the nozzle comprises the discharge port.

According to an aspect, the nozzle comprises a pair of blades guiding the air exhausted at the discharge port.

According to an aspect, at least one of the blades from the pair of blades comprises ribs.

According to an aspect, the snow blower further comprises thermally conducting spines housed by the ribs that are thermally connected to the heating coil.

According to an aspect, the snow blower further comprises a power chamber housing the electric circuit and the electric blower, wherein the power chamber is fluidly connected to the intake port.

According to an aspect, the snow blower further comprises a handle comprising extremities, a first one of the extremities being secured to the power chamber and a second one of the extremities being secured to the conduit.

According to an aspect, the handle defines a hollow passage fluidly connecting the conduit and the power chamber.

According to an embodiment, there is provided a snow blower for removal of at least one of snow and ice from a surface, the snow blower comprising: an intake port; an electric blower; and a nozzle comprising a pair of blades protruding away from each other and defining a discharge port therebetween for guiding air exhausted from the discharge port towards the surface, wherein air is forced by the electric blower from the intake port to be exhausted at the discharge port to contribute to remove the at least one of snow and ice from the surface.

According to an aspect, one of the blades of the pair of blades comprises ribs.

According to an aspect, the snow blower further comprises a power chamber housing the electric circuit and the electric blower, wherein the power chamber is fluidly connected to the intake port.

According to an aspect, the snow blower further comprises a handle comprising extremities, a first one of the extremities being secured to the power chamber and a second one of the extremities being secured to the conduit distant from the intake port.

According to an aspect, the handle defines a hollow passage fluidly connecting the conduit and the power chamber.

According to an aspect, the snow blower further comprises a one-way valve, wherein the one-way valve operates upon excessive air pressure inside the snow blower.

According to an embodiment, there is provided a snow blower for removal of at least one of snow and ice from a surface, the snow blower comprising: an intake port; a discharge port; a conduit comprising an interior wall; a heating coil mounted to the conduit along the interior wall and extending over a portion of a length of the conduit; and an electric blower for drawing air through the intake port and exhausting air heated by the heating coil through the discharge port via the conduit; wherein air exhausted at the discharge port to contribute to remove the at least one of snow and ice from the surface.

According to an aspect, the conduit comprises: an extension duct; and a nozzle, wherein the extension duct and the nozzle are releasably attached and fluidly connected to each other, and wherein the nozzle comprises the discharge port.

According to an aspect, the nozzle comprises a pair of blades (350) guiding the air exhausted at the discharge port.

According to an aspect, one of the pair of blades comprises ribs.

According to an aspect, the snow blower further comprises a power chamber and a handle comprising extremities, a first one of the extremities being secured to the power chamber and a second one of the extremities being secured to the conduit.

According to an aspect, the handle defines a hollow passage fluidly connecting the conduit and the power chamber.

According to an aspect, the snow blower further comprises an electric circuit and a power chamber housing the electric circuit and the electric blower, wherein the power chamber is fluidly connected to the intake port.

### BRIEF DESCRIPTION OF THE DRAWINGS

Further features and advantages of the present disclosure will become apparent from the following detailed description, taken in combination with the appended drawings, in which:

FIG. 1 is a side perspective view of a first embodiment of a snow blower;

FIGS. 2a-2b are side and front elevation views of an extension duct in accordance with an embodiment;

FIGS. 3a-3d are respectively a side perspective view, a top view, a front elevation view and a side elevation view of a nozzle in accordance with an embodiment; and

FIG. 4 is a schematic view of a power cord to be attached to the snow blower in accordance with an embodiment.

### DETAILED DESCRIPTION

It will be noted that, for the sake of clarity and understanding, spatial references such as top, bottom, front and back are used for teaching purpose only and do not limit the use or structure of the embodiments of snow blower more than limitation regarding the relative components, relative locations and configurations of the different parts of the embodiments of snow blower herein described.

It will be noted that the terms upstream and downstream are further used to identify components, component parts and locations, these terms referring to the flow of air within the snow blower.

Furthermore, it will be noted that snow and ice are used as example of materials to be removed, based on its characteristics. However, the embodiments of snow blower may be used in relation with other material sharing at least some of the characteristics of snow and ice without departing from the intended scope of the present teaching.

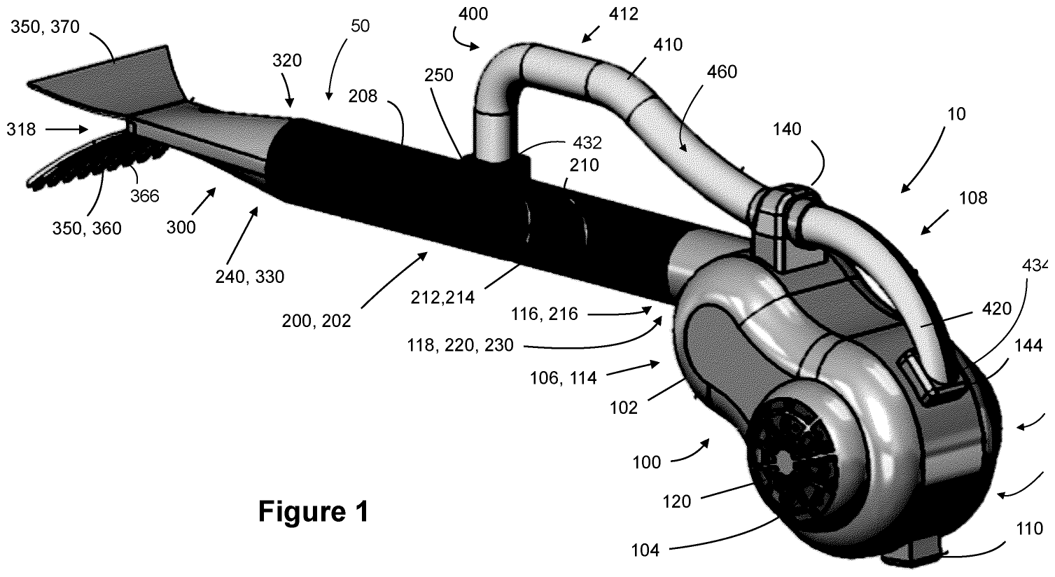

Referring now to the drawings, and more particularly to FIG. 1, a first embodiment of the snow blower 10 consists in a handheld power tool adapted to be easily operated by a single person in different conditions and orientations. The snow blower 10 comprises a body 50 that comprises up to four parts, namely a power chamber 100, an extension duct 200, a nozzle 300 and a handle 400. The snow blower 10 is adapted to be operated in an assembled configuration, the four parts 100, 200, 300 and 400 assembled in a single operable tool. However, it will be noted that parts may be handled independently and replaced with other parts, and assembled partially without departing from the present teaching.

Referring to FIG. 1, the power chamber 100 comprises a body 102 housing an electric blower 104 located in a blower chamber communicating with the environment through an intake port 120 and with an outlet port 218. The electric blower 104 is electrically powered by a power source, namely a rechargeable battery cell 106 (not shown) housed within the body 102. The power chamber 100 further comprises a power switch 108 (not visible) for turning on or off the electric blower 104. The power chamber 100 further comprises an electric socket 110 for plugging a power cord 500 (see FIG. 4) either for charging the battery cell 106 or for powering the electric blower 104 through connection to the grid. The power chamber 100 also comprises an electric circuit 114 (not shown) connecting the electric socket 110, the battery cell 106, the power switch 108, the electric blower 104 and a heater contact 116.

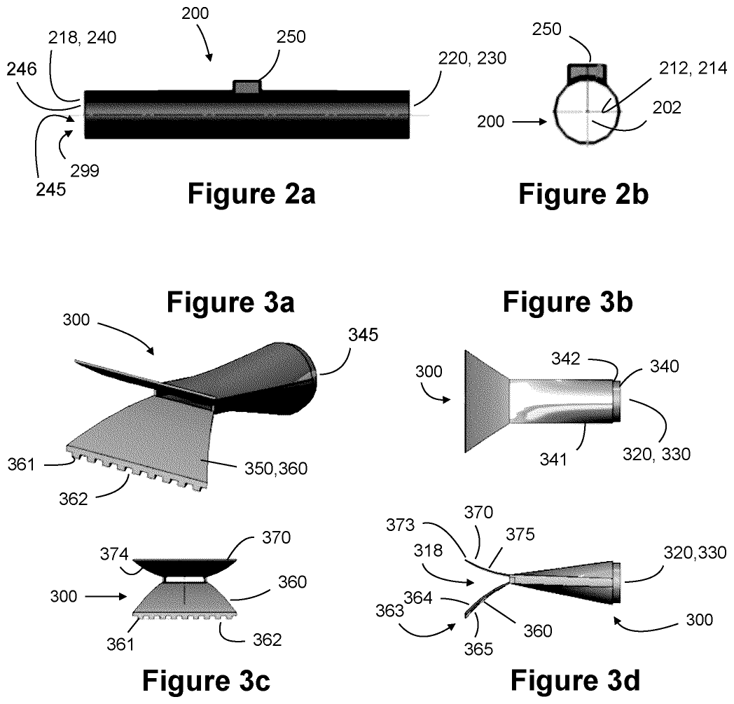

Referring additionally to FIG. 2, an extension duct 200 defines a conduit 202 that is adapted to connect on the outlet port 118 of the power chamber 100. The extension duct 200 consists substantially of a hollow pipe extending from an upstream extremity to an downstream extremity, the extension duct 200 housing a heating component, a.k.a. an electric heating coil 210 (see FIG. 1). The extension duct 200 defines a circular input port 220 at its upstream extremity 230; the circular input port 220 mating the shape of the outlet port 118 of the power chamber 100; and allowing easy connection of the extension duct 200 to power chamber 100 via, for example, a twist motion. A straight tight fit friction connection is also contemplated.

The heating coil 210 housed in the extension duct 200 is wound on the interior wall 212 of the extension duct 200 following the interior surface 214 and extending longitudinally over a distance corresponding to a portion of the length of the extension duct 200. The extension duct 200 comprises at its upstream extremity 230 a heater connector 216 (not visible) that, upon assembly of the extension duct 200 to the power chamber 100, connects to the matching heater contact 116 of the power chamber 100. The heating coil 210 comprising the heater connector 216 is therefore, upon assembly, electrically connected to the power chamber 100 and capable of being powered by the battery cell 106 housed in the power chamber 100.

The heating coil 210, disposed along the interior wall 212 of the extension duct 200, is in contact with flowing air. The heating coil 210 is designed to heat the air without hindering its flow. The heating coil 210 further heats a portion of the interior wall 212 of the extension duct 200. The extension duct 200 being made of electrically insulating material, the electric current powering the heating coil 210 is prevented from being communicated to the exterior wall 208 of the extension duct 200, ensuring safety of the operator. The extension duct 200 also being made of thermally insulating material, a low portion of the heat generated by the heating coil 210 reaches the exterior wall 208 of the extension duct 200.

The extension duct 200 further comprises on top, distant from its upstream extremity 230, a bracket 250 for fastening a front extremity of the front handle 410.

Referring to FIG. 1, the snow blower 10 comprises a handle 400 extending between two extremities 432, 434 and comprising a front handle 410 and a back handle 420. The front handle 410 is attached at its front to the bracket 250 of the extension duct 200, and at its back to a front protrusion 140 of the power chamber 100. The front handle 410 extends substantially longitudinally. The handle 400 comprises a back handle 420 extending from the front protrusion 140 to a back protrusion 144 of the power chamber 100. The front protrusion 140 and the back protrusion 144 comprise brackets (not shown) for securing rigidly the extremities of the handle 400. The front handle 410 and the back handle 420 extend substantially longitudinally; they provide an ergonomic configuration for operation, to have a first hand of an operator gripping the back handle 420 for supporting substantially the weight of the snow blower 10 and the second hand gripping the front handle 410 closer to the nozzle 300 for the operator to easily orientate the snow blower 10.

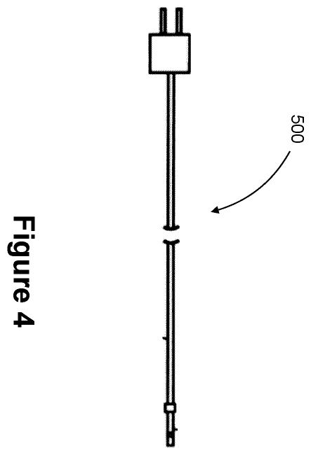

Referring now to FIG. 1 and FIGS. 3a-d, the snow blower 10 further comprises a nozzle 300 to be attached to the downstream extremity 240 of the extension duct 200 through its upstream extremity 330. The nozzle 300 defines an inlet port 320 at its upstream extremity 330; the inlet port 320 mating the shape of the extension duct 200 and allowing easy connection of the nozzle 300 to the extension duct 200 via a twist motion. Again, a straight tight fit friction connection is also contemplated.

The shape of the nozzle 300 between its upstream extremity 330 and its discharge port 318 evolves from a circular shape to an elongated rectangular shape at which two blades 350 extend. The rectangular shape of the discharge port 318 promotes the heated air to flow close to the blades 350, the flow of hot air forming a powered wave capable of removing snow located close to the blades 350 and melting snow and ice attached to a surface and resisting the pressure of the heated air flow.

It will be noted that the nature of the heating coil 210 following the interior wall 212, the gradual evolution of the shape of the nozzle 300 from a circular shape at its inlet port 320 to a rectangular shape and the shape of the blades 350 favour a laminar flow of air at the discharge port 318 of the nozzle 300.

Regarding more specifically the blades 350, they are designed to be interchangeable based on needs; the nozzle 300 being installed in a first configuration or a second configuration based on the blade 350 the operator wishes to use. On FIGS. 1 and 3a to 3d, the bottom blade is an ice scraper blade 360 comprising a series of teeth 361 and gaps 362 between the teeth 361 at its operating end, a.k.a. edge 363. The ice scraper blade 360 features a smooth interior face 364 easing the flow of heater air and an exterior face 365 comprising a series of ribs 366 strengthening the ice scraper blade 360 for applications such as scraping a surface to which ice and snow are fixed. The top blade is a general use blade 370 featuring smooth interior surface 374 and exterior surface 375. The general use blade 370 has a regular edge 373 for smooth surfaces and light-scraping conditions.

Regarding the assembly of the nozzle 300 to the extension duct 200, it takes advantage of resiliency of the material of the nozzle 300 and the extension duct 200. According to the illustrated first embodiment, the nozzle 300 comprises at its upstream extremity 330 an assembly ring 340 of a smaller outer diameter than the body 341 of the nozzle 300, thereby defining a shoulder 342. The assembly ring 340 is for inserting in a mating portion at the downstream extremity 240 of the extension duct 200; mating with a duct assembly section 299 of similar interior diameter.

According to an embodiment, the assembly ring 340 and the duct assembly section 299 feature a lip/groove combination extending along the circumference of the assembly ring 340 and the duct assembly section 299. When assembled (by forcing the assembly ring 340 in the duct assembly section 299), the lip 345 lands in the groove 245, and the edge 246 of the downstream extremity 240 of the extension duct 200 abuts the shoulder 342, locking the components in an assembled configuration. The circular shape of the assembly allows to orientate the nozzle 300 to have the desired blade 350 in an operating position without having to disconnect the components.

According to the first embodiment, the snow blower 10 comprises an electric blower 104 with an intake port 120 located on one side of the power chamber 100; the electric blower 104 being mounted relative to a horizontal power shaft (not shown). According to another embodiment (not shown), the snow blower 10 comprises an intake port located under the power chamber 100 with the electric blower 104 being mounted to a power shaft having an axis, forming part of a vertical plane, extending along the longitudinal orientation of the snow blower 10.

According to an embodiment (not shown), the battery cell 106 is located in the power chamber 100 in front of the electric blower 104. The air flow forced by the electric blower 104 in the power chamber 100 flows around a portion of the battery cell 106 or flows along a cooling surface in contact with the battery cell 106 for the air flow to cool down battery cell 106.

According to the illustrated embodiment, the electric socket 110 is downwardly facing to provide a flat support face to support the snow blower 10 when laid down on the ground. According to another embodiment, a support protrusion is located at the illustrated current location of the electric socket 110 and the electric socket 110 is located closer to the handle 400. According to embodiments, the electric socket 110 is facing downward or sideward for preventing falling snow from accumulating around the electric socket 110.

According to embodiments, the snow blower 10 comprises a series of switch positions controlled by one or more switches. One feature controlled by the switch positions is powering the electric blower 104. An optional feature controllable with the switch positions is the speed of the electric blower 104, thus the air flow. According to one embodiment, the electric blower 104 can be powered up to spin at least at two distinct speeds. Another optional feature controllable with the switch positions is the powering of the heating coil 210. According to an embodiment, the snow blower 10 may be operated with the heating coil 210 not turned on, the air exhausted from the nozzle 300 not being heated. Such an operating condition may be used when the heating would not provide advantages, such as for blower alternative material such as leaves or dust. Additional temperature controls may be present for controlling the heating coil 210. These features are intended to prolong the life use of the snow blower 10 over a single charge when operating solely on battery cell 106 power. It will be understood that some or more of the listed switch positions may be realized through a single power switch capable of landing on multiple setting locations with the electric circuit 114 adapted thereof to operate according to the corresponding settings, or a plurality of physical switches individually controlling distinct features, for instance one general powering switch and one heat control switch, with the electric circuit 114 designed accordingly.

According to the illustrated embodiment, the front handle 410 features a horizontal portion 412 close to the bracket 250 and is for gripping purposes. The horizontal portion 412 provides a clearance between the front handle 410 and the extension duct 200 for easy gripping. According to an alternative embodiment (not shown), the handle 400 comprises an orientable handle to be secured to the front handle 410, the orientable handle extending laterally from the front handle 410 for improved ergonomic operation.

According to an embodiment, the extension duct 200 comprises a heat dissipating surface (not shown). The heat dissipation surface extends over a substantial portion of the length of the interior wall 212 of the extension duct 200. The heating coil 210 is in contact with the heat dissipation surface, the heating coil 210 heating the heat dissipation surface. Accordingly, the surface heating the flowing air is improved with respect to the heating coil 210 alone.

According to embodiments, the electric connection between the power chamber 100 and the extension duct 200 may take many forms. According to the illustrated embodiment, the configuration of the junction sections of the power chamber 100 and the extension duct 200 used to assemble these parts feature embedded electrical connectors (heater connector 216 and heater contact 116) that when assembled in a right aligned configuration define a close electric circuit connecting the heating coil 210 to electric circuit 114 of the power chamber 100. According to another embodiment (not shown), an external connection involving a combination of a plug at the end of a power cord on, for example the extension duct 200, and a socket to connect the plug on to other one of the assembled components, for example the power chamber, is used to close the electric circuit.

According to another embodiment, the nozzle 300 features heating components (not shown) near or at the teeth of the ice scraper blade 360. The heating components according to an embodiment (not shown) are thermally conducting spines located within the ribs 366 conducting heat from the interior wall 212 of the extension duct 200 to the ice scraper blade 360 of the nozzle 300. The spines end at open locations on the surface of the ice scraper blade 360, close to its edge 363. This realization involves a heat transmitting component, typically a metallic component, heated by the heating coil 210 but electrically insulated from the heating coil 210 at one extremity, that thermally connects to the spines at the other extremity. Connection between the heat transmitting component and the spines may take a similar for as the one described in relation with the electric connection of the extension duct 200 to the power chamber 100.

According to another embodiment, the handle 400 consists in a hollow tube defining a hollow passage 460. The extension duct 200 features, at the location of the bracket 250, an opening fluidly connecting the interior of the extension duct 200 to the interior of the handle 400, namely the hollow passage 460. At the other end of the handle 400, the power chamber 100 comprises an opening operating as a backflow port for a portion of the backflowing air from the extension duct 200 to flow back to the power chamber 100. The pre-heat back flowing air increases the temperature of the mix of air exhausted by the electric blower 104.

According to an embodiment (not shown), the hollow handle 400, at its entry, at its exit or somewhere in-between houses a one-way valve opening when pressure exceeds a pre-set level. Accordingly, if the nozzle 300 becomes at least partially plugged, by ice for instance, preventing heated air from being exhausted correctly at the nozzle 300, part of the heated air gets in the mix of air feeding the electric blower 104 thereby increasing the temperature of the heated air to eject by the nozzle 300.

According to an embodiment (not shown), a temperature gauge is connected to the electric circuit 114 of the power chamber 100 to monitor the air temperature, and to turn off the power of the heating coil 210 when reaching a pre-set temperature. The temperature gauge and short circuit prevents overheating of the electric blower 104 and the battery cell 106. According to an embodiment, the temperature gauge is located in the power chamber 100 either between the electric blower 104 and the outlet port 118, or between the backflow port and the electric blower 104.

According to an embodiment (not shown), the handle 400 features thermal isolation preventing risk of burning the hands of the operator.

It will be noted that many options have been described herein as distinct embodiments. The teaching of these options as distinct embodiments is solely for easing the teaching, and does not limit the number or options and the nature of the options that may be implemented in one embodiment. It is the intent of teaching the whole breath of combinations of options though these distinct embodiments.

It will also be noted that the present snow blower 10 may be used for a variety of purposed else than blowing snow and ice, comprising without limitation blowing leaves, blowing pebbles and gravel, blowing dust and low-density material in a variety of locations and on a variety of surface types, drying surfaces, and blowing up items such as balls and mattresses.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A snow blower for removal of at least one of snow and ice from a surface, the snow blower comprising:
a body;
an intake port;
a discharge port;
a conduit having an interior wall, the conduit fluidly connecting the intake port to the discharge port;
a power source housed within the body;
an electric circuit housed within the body and electrically connected to the power source;
an electric blower housed within the body and powered by the electric circuit; and
a heating coil electrically connected to the electric circuit, extending along and wound on at least a portion of the interior wall,
wherein air is forced by the electric blower from the intake port through the conduit, heated by the heating coil and exhausted at the discharge port to contribute to remove the at least one of snow and ice from the surface.

2. The snow blower of claim 1, further comprising:
an extension duct which forms the conduit; and
a nozzle, wherein the nozzle is releasably attached and fluidly connected to the extension duct,
and wherein the nozzle comprises the discharge port.

3. The snow blower of claim 2, wherein the nozzle comprises a pair of blades guiding the air exhausted at the discharge port.

4. The snow blower of claim 3, wherein at least one of the blades from the pair of blades comprises ribs.

5. The snow blower of claim 4, further comprising thermally conducting spines housed by the ribs that are thermally connected to the heating coil.

6. The snow blower of claim 1, further comprising a power chamber housing the electric circuit and the electric blower, wherein the power chamber is fluidly connected to the intake port.

7. The snow blower of claim 6, further comprising a handle comprising extremities, a first one of the extremities being secured to the power chamber and a second one of the extremities being secured to the conduit.

8. The snow blower of claim 7, wherein the handle defines a hollow passage fluidly connecting the conduit and the power chamber.

9. The snow blower of claim 8, further comprising a none-way valve mounted to the handle and fluidly connected to environment, wherein the one-way valve operates upon air pressure exceeding a preset value therein to decrease air pressure within the handle.

10.-14. (canceled)

15. A snow blower for removal of at least one of snow and ice from a surface, the snow blower comprising:
an intake port;
a discharge port;
a conduit comprising an interior wall;
a heating coil mounted to the conduit along the interior wall, wound on the interior wall, and extending over a portion of a length of the conduit; and
an electric blower for drawing air through the intake port and exhausting air heated by the heating coil through the discharge port via the conduit;
wherein air exhausted at the discharge port to contribute to remove the at least one of snow and ice from the surface.

16. The snow blower of claim 15, wherein the conduit comprises:
an extension duct; and
a nozzle,
wherein the extension duct and the nozzle are releasably attached and fluidly connected to each other, and wherein the nozzle comprises the discharge port.

17. The snow blower of claim 16, wherein the nozzle comprises a pair of blades guiding the air exhausted at the discharge port.

18. The snow blower of claim 17, wherein one of the pair of blades comprises ribs.

19. The snow blower of claim 15, further comprising a power chamber and a handle comprising extremities, a first one of the extremities being secured to the power chamber and a second one of the extremities being secured to the conduit.

20. The snow blower of claim 19, wherein the handle defines a hollow passage fluidly connecting the conduit and the power chamber.

21. The snow blower of claim 15, further comprising an electric circuit and a power chamber housing the electric circuit and the electric blower, wherein the power chamber is fluidly connected to the intake port.

22. The snow blower of claim 15, further comprising a power source to which is electrically connected one of the heating coil and the electric blower.

23. The snow blower of claim 17, further comprising thermally conductive spine housed by the blades and thermally connected to the heating coil.

24. The snow blower of claim 19, further comprising a handle comprising extremities, a first one of the extremities being secured to the power chamber and a second one of the extremities being secured to the conduit, wherein the handle defines a hollow passage fluidly connecting the conduit and the power chamber.

25. The snow blower of claim 24, further comprising a none-way valve mounted to the handle and fluidly connected to environment, wherein the one-way valve operates upon air pressure exceeding a preset value therein to decrease air pressure within the handle.
